(19) United States
(12) Patent Application Publication
(10) Pub. No.: US 2009/0024718 A1
(43) Pub. Date: Jan. 22, 2009

(54) Just-In-Time Contextual Advertising Techniques

(76) Inventors: Aris Anagnostopoulos, San Francisco, CA (US); Andrei Z. Broder, Menlo Park, CA (US); Evgeniy Gabrilovich, Sunnyvale, CA (US); Vanja Josifovski, Los Gatos, CA (US); Lance Riedel, Menlo Park, CA (US)

Correspondence Address: STATTLER - SUH PC, 60 SOUTH MARKET STREET, SUITE 480, SAN JOSE, CA, 95113, US

(21) Appl. No.: 11/781,184

(22) Filed: Jul. 20, 2007

(51) Int. Cl. G06F 15/16

(52) U.S. Cl. 709/218

(57) ABSTRACT

A system and method to facilitate real-time matching of content to advertising information in a network are described. A request for advertising information is received over a network, the advertising information to be displayed for a user entity in association with content information within a web page requested by the user entity, the request containing the content information, a web page identifier, and additional data associated with the web page. The content information is further analyzed in real-time to construct a page summary of the web page. The web page identifier and the additional data are further analyzed in real-time to extract at least one keyword relevant to the content information. Finally, the advertising information is determined in real-time based on the page summary and the extracted keywords.

### TECHNICAL FIELD

The present invention relates generally to the field of network-based communications and, more particularly, to a system and method to facilitate real-time matching of content to advertising information in a network, such as the Internet.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

Web advertising supports a large swath of today's Internet ecosystem. A large portion of the advertising market over the Internet consists of textual advertisements or ads, which encompass short text messages distributed to the users. One main advertising channel used to distribute textual ads is the sponsored search advertising channel, which consists in placing ads on the results pages from a web search engine, with ads driven by the originating query. Another main advertising channel is the contextual advertising channel which refers to the placement of commercial ads within the content of a generic web page.

Given a specific page, rather than placing generic ads, it would be preferable to display ads related to the content of the page to provide a better user experience and to increase the probability of user clicks. Previous approaches estimated the ad relevance based on the co-occurrence of the same words or phrases within the ad and within the page. However, targeting mechanisms based solely on phrases found within the text of the page can lead to erroneous results, for example, a page about a famous golfer named “John Maytag” might trigger an ad for “Maytag dishwashers,” since Maytag is a popular appliance brand.

Furthermore, when the page content is static (that is, the content associated to the given Uniform Resource Locator is not generated on-the-fly and changes infrequently), the servers can invest computation resources in a one-time offline process that involves fetching of the entire page and performing deep analysis of the page content to facilitate future advertisement matches. However, ads need to be matched also to new pages or to dynamically created pages that cannot be processed ahead of time, and analyzing the entire body of such web pages at display-time entails prohibitive communication and latency costs.

Thus, it would be advantageous to provide a system and method to facilitate production of highly relevant advertisements without any pre-crawling of the web pages and through use of a modest amount of processing and communication resources at advertisement display time.

### SUMMARY OF THE INVENTION

A system and method to facilitate real-time matching of content to advertising information in a network are described. A request for advertising information is received over a network, the advertising information to be displayed for a user entity in association with content information within a web page requested by the user entity, the request containing the content information, a web page identifier, and additional data associated with the web page. The content information is further analyzed in real-time to construct a page summary of the web page. The web page identifier and the additional data are further analyzed in real-time to extract at least one keyword relevant to the content information. Finally, the advertising information is determined in real-time based on the page summary and the extracted keywords.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a method to facilitate real-time processing of page content and matching of the content to advertising information, according to one embodiment of the invention;

FIG. 2 is a block diagram illustrating an exemplary network-based entity containing a system to facilitate real-time matching of content to advertising information, according to one embodiment of the invention;

FIG. 3 is a block diagram illustrating an exemplary interface to display content and associated advertising information for the user, according to one embodiment of the invention;

FIG. 4 is a block diagram illustrating the system to facilitate real-time matching of content to advertising information within the network-based entity, according to one embodiment of the invention;

FIG. 5 is a block diagram illustrating a data storage module within the network-based entity, according to one embodiment of the invention;

FIG. 6A is a flow diagram illustrating a method to process page content information received at the network-based entity, according to one embodiment of the invention;

FIG. 6B is a flow diagram illustrating a method to process data associated to the web page and to classify the page content, according to one embodiment of the invention;

FIG. 7 is a flow diagram illustrating a method to process advertisements received at the network-based entity, according to one embodiment of the invention;

FIG. 8 is a flow diagram illustrating a method to facilitate semantic matching of content to corresponding advertising information, according to one embodiment of the invention;

FIG. 9 is a flow diagram illustrating a method to facilitate syntactic matching of content to corresponding advertising information, according to one embodiment of the invention;

FIG. 10 is a flow diagram illustrating a method to optimize selected advertisements for subsequent display to the user, according to one embodiment of the invention;

FIG. 11 is a flow diagram illustrating a method to update a mapping database within the data storage module based on the optimized advertisements and the associated content, according to one embodiment of the invention;

FIG. 12 is a diagrammatic representation of a machine in the exemplary form of a computer system within which a set of instructions may be executed.

### DETAILED DESCRIPTION

In the following description, numerous details are set forth for purpose of explanation. However, one of ordinary skill in the art will realize that the invention may he practiced without the use of the specific details. In other instances, well-known structures and devices are shown in block diagram form in order not to obscure the description of the invention with unnecessary detail.

In embodiments described in detail below, users access an entity, such as, for example, a content service provider, over a network such as the Internet and further input various data, which is subsequently captured by selective processing modules within the network-based entity. The user input typically comprises one or more “events.” In one embodiment, an event is a type of action initiated by the user, typically through a conventional mouse click command. Events include, for example, advertisement clicks, search queries, search clicks, sponsored listing clicks, page views and advertisement views. However, events, as used herein, may include any type of online navigational interaction or search-related events.

Each of such events initiated by a user triggers a transfer of content information to the user, the content information being typically displayed in a web page on the user's client computer. The web page incorporates content provided by publishers, such as, for example, articles, and/or other data of interest to users, often displayed in a variety of formats. In addition, the web page may also incorporate advertisements provided on behalf of various advertisers over the network by an advertising agency, which may be included within the entity, or in the alternative, may be coupled to the entity and the advertisers, for example.

In embodiments described in detail below, the entity constructs in real-time a page summary of the content displayed within the web page and further analyzes additional data related to the web page to extract keywords relevant to the page content. The entity subsequently classifies the page content into respective content categories of a content database based on the page summary and the associated keywords. Next, the entity selects the advertisements to be displayed within the web page, such that each advertisement is contextually related to the page content information provided by the publishers. In addition, each advertisement matches any text and metadata information displayed within the web page and additional parameters applied by the entity, as described in detail below. In alternate embodiments, other classifications of web pages and advertisements may be used, such as classifications based on user interests, as determined by a behavioral targeting system, for example.

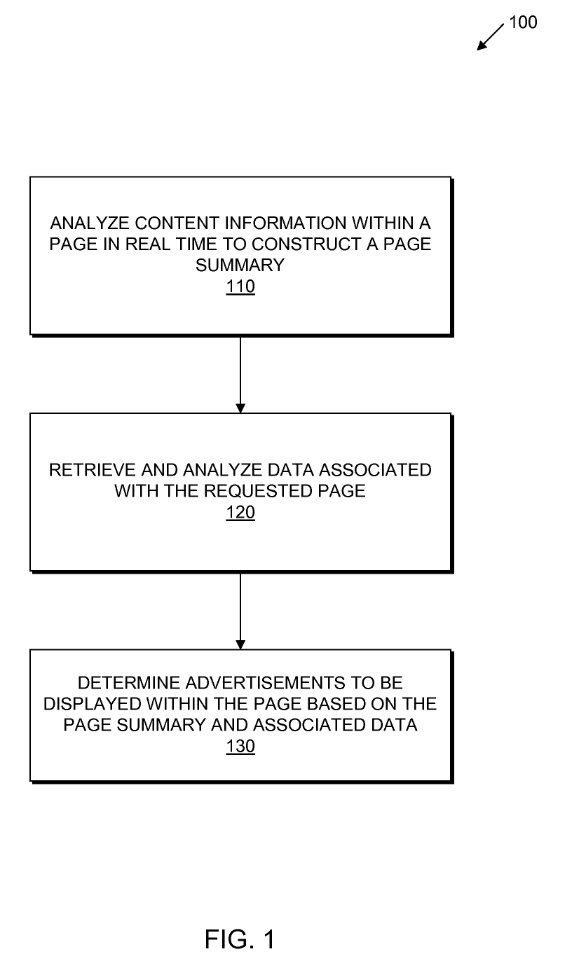

FIG. 1 is a flow diagram illustrating a method to facilitate real-time processing of page content and matching of the content to advertising information, according to one embodiment of the invention. As shown in FIG. 1, the sequence 100 starts at processing block 110 with real-time analysis of the content information within a web page requested by a user to construct a page summary of the content information, as described in further detail below.

In one embodiment, users or agents of the users access a publisher over a network and request a web page populated with content information. Generally, the content information is presented to the user in a variety of formats, such as, for example, text, images, video, audio, animation, program code, data structures, hyperlinks, and other formats. The content is typically presented as a web page and may be formatted according to the Hypertext Markup Language (HTML), the Extensible Markup Language (XML), the Standard Generalized Markup Language (SGML), or any other known language.

The publisher further transmits the requested web page content information to the user to be displayed on the user's machine. At the same time, while the web page is being displayed, a JavaScript call routine, or, in the alternative, a Hypertext Transfer Protocol (HTTP) call routine, residing or embedded onto the web page is transmitted to the entity to request advertisements for insertion into the web page via an iframe mechanism, or JavaScript, or any other known embedding mechanism. In one embodiment, the request for advertisements contains the Uniform Resource Locator (URL) of the web page and additional data related to the web page.

In an alternate embodiment, upon receipt of the web page request, the publisher may access the entity to request advertisements for insertion into the web page prior to display of the web page on the client machine associated with the user.

The entity receives the advertising request and the web page information and analyzes the page content in real-time to construct a page summary, as described in further detail below.

Next, referring back to FIG. 1, at processing block 120, additional data associated with the web page is retrieved and analyzed. In one embodiment, the entity analyzes the data related to the web page, such as, for example, the page URL, the URL of a referrer page from where the user arrived to the current page, to extract one or more keywords, as described in further detail below.

Finally, at processing block 130, the sequence continues with a determination of advertising information to be displayed within the web page requested by the user based on the constructed page summary and the extracted associated keywords, as described in further detail below. As used herein, in one embodiment, advertising information is sent to the user that requests the web page and includes multiple advertisements, which may include a hyperlink, such as, for example, a sponsor link, an integrated link, an inside link, or other known link. The format of an advertisement may or may not be similar to the format of the content displayed on the web page and may include, for example, text advertisements, graphics advertisements, rich media advertisements, and other known types of advertisements. Alternatively, the advertisements are transmitted to the publisher, which assembles the web page content and the advertisements for display on the client machine coupled to the user.

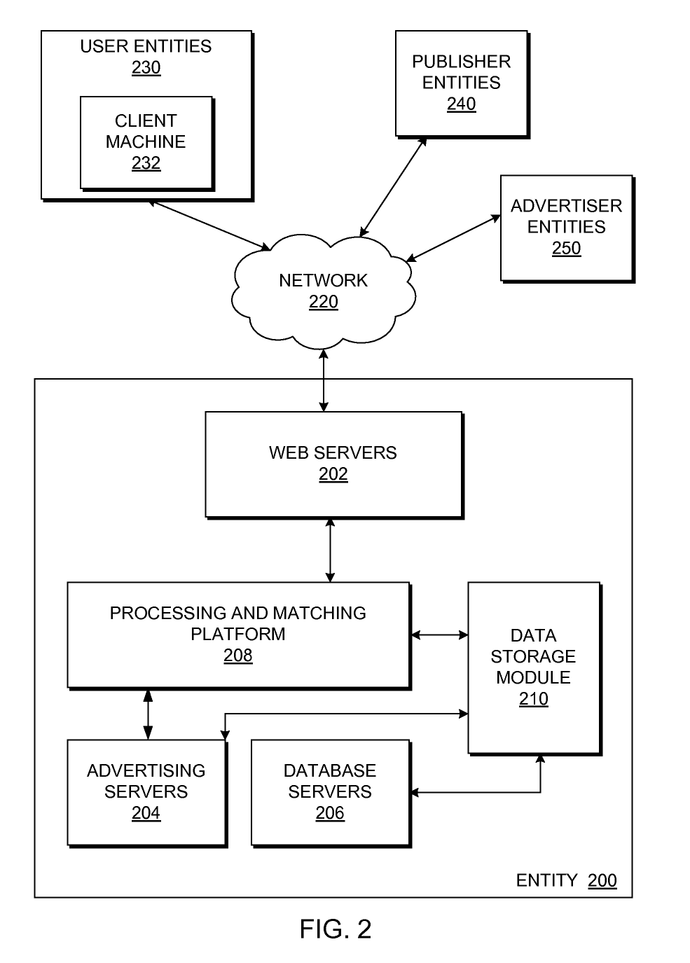

FIG. 2 is a block diagram illustrating an exemplar/network-based entity containing a system to facilitate real-time matching of content to advertising information. While an exemplary embodiment of the invention is described within the context of an entity 200 enabling automatic real-time matching of web page content to advertising information, it will be appreciated by those skilled in the art that the invention will find application in many different types of computer-based, and network-based, entities, such as, for example, commerce entities, content provider entities, or other known entities having a presence on the network.

In one embodiment, the entity 200 is a network content service provider, such as, for example, Yahoo! and its associated properties, and includes one or more front-end web processing servers 202, which may, for example, deliver web pages to multiple users, (e.g., markup language documents), and/or handle search requests to the entity 200, and/or provide automated communications to/from users of the entity 200, and/or deliver images to be displayed within the web pages, and/or deliver content information to the users in various formats. The entity 200 may further include other processing servers, which provide an intelligent interface to the back-end of the entity 200.

The entity 200 further includes one or more back-end servers, for example, one or more advertising servers 204, and one or more database servers 206. Each server maintains and facilitates access to one or more data storage modules 210. In one embodiment, the advertising servers 204 are coupled to the data storage module 210 and are configured to transmit and receive advertising content, such as, for example, advertisements, sponsored links, integrated links, and other known types of advertising content, to/from advertiser entities via the network 220. In one embodiment, the entity 200 further includes a system to facilitate real-time matching of content to advertising information within the network-based entity 200, as described in further detail below. The system further comprises a processing and matching platform 208 coupled to the data storage module 210. The platform 208 is further coupled to the web servers 202 and the advertising servers 204.

The network-based entity 200 may be accessed by a client program, such as a browser (e.g., the Internet Explore™ browser distributed by Microsoft Corporation of Redmond, Wash., Netscape's Navigator™ browser, the Mozilla® browser, a wireless application protocol enabled browser in the case of a cellular phone, a PDA or other wireless device), that executes on a client machine 232 of a user entity 230 and accesses the entity 200 via a network 220, such as, for example, the Internet. Other examples of networks that a client may utilize to access the entity 200 includes a wide area network (WAN), a local area network (LAN), a wireless network (e.g., a cellular network), a virtual private network (VPN), the Plain Old Telephone Service (POTS) network, or other known networks.

In one embodiment, other network entities may also access the network-based entity 200 via the network 220, such as, for example, publishers 240, which communicate with the web servers 202 and the users 230 to populate web pages with appropriate content information and to display the web pages for the users 230 on their respective client machines 232, and advertisers 250, which communicate with the web servers 202 and the advertising servers 204 to transmit advertisements to be subsequently displayed in the web pages requested by the users 230. The publishers 240 are the owners of the web pages on which the advertisements are displayed and typically aim to maximize advertising revenue while providing a good user experience. The advertisers 250 supply the ads in specific temporal and thematic campaigns and typically try to promote products and services during those campaigns,

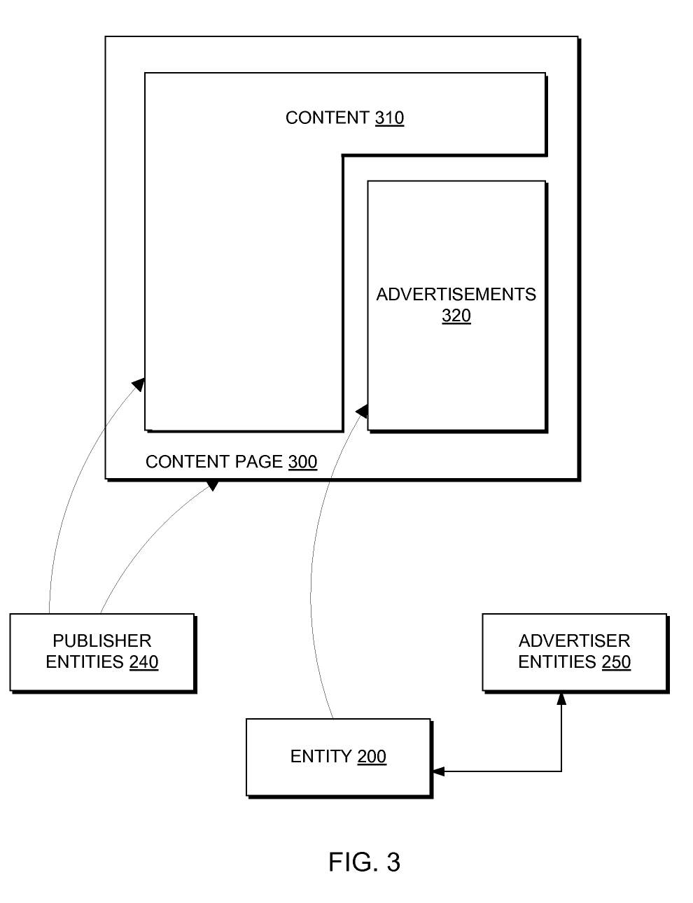

FIG. 3 is a block diagram illustrating an exemplary interface to display content and associated advertising information for the user, according to one embodiment of the invention. As illustrated in FIG. 3, a content page 300, such as, for example, a web page requested by a user or an agent of the user, incorporates content information provided by the publishers 240 and displayed in a content area 310. In one embodiment, content may include published information, such as, for example, articles, and/or other data of interest to users, often displayed in a variety of formats, such as text, video, audio, hyperlinks, or other known formats.

The web page 300 further incorporates advertisements provided by the advertisers 250 via the entity 200 or, in the alternative, the advertising agency (not shown), which may be included within the entity 200, or in the alternative, may be coupled to the entity 200 and the advertisers 250, for example. In another alternate embodiment, the advertisements may be transmitted to the publishers 240 for subsequent transmission to the users 230.

The advertisements are further displayed in an advertisements area 320. The web page 300 is finally composed and displayed within the client browser running on the client machine 232 associated with the user.

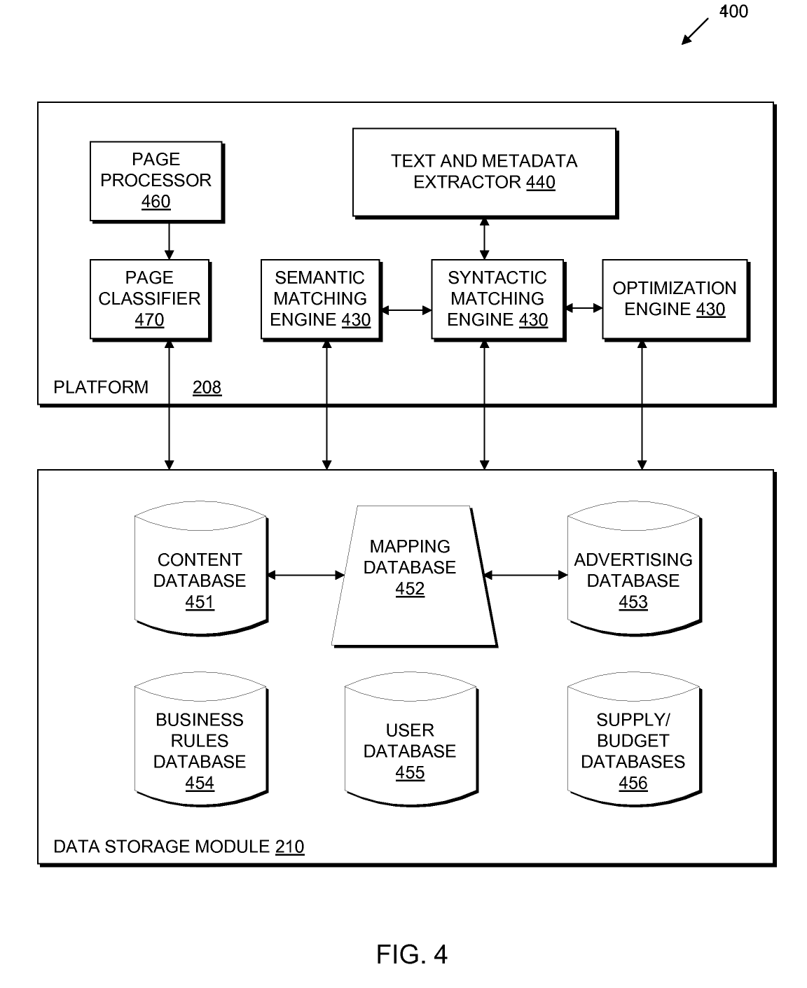

FIG. 4 is a block diagram illustrating a system 400 to facilitate real-time matching of content to advertising information within the network-based entity 200, according to one embodiment of the invention. As illustrated in FIG. 4, the system 400 includes the processing and matching platform 208 coupled to multiple databases within the data storage module 210, such as, for example, a content database 451, an advertising database 453, and a mapping database 452 coupled to the content database 451 and the advertising database 453, as described in further detail below. The data storage module 210 may further include other databases, such as, for example, a business rules database 454, a user database 455, supply/budget databases 456, and other databases (not shown) specifically provided to enable exemplary embodiments of the present invention.

In one embodiment, the processing and matching platform 208 within the system 400 enables matching of the page content to related advertisements based on data stored in the associated databases 451 through 456, as described in further detail below.

In one embodiment, the platform 208 includes a semantic matching engine 410, which is a hardware and/or software module configured to determine which advertisements classified in respective advertising categories are related to one or more themes of the web page requested by the user entity 230 from the publisher 240, such as, for example, one or more general subject matters contextually related to content presented on the web page.

The platform 208 further includes a text and metadata extractor 440, which is a hardware and/or software module configured to extract keywords and associated metadata from web pages, and a syntactic matching engine 420 coupled to the text and metadata extractor 440. The syntactic matching engine 420 is a hardware and/or software module configured to select advertisements that closely match the extracted keywords and metadata and further match a set of predetermined parameters retrieved from respective databases, such as, for example, the business rules database 454, the user database 455, and/or the supply/budget databases 456.

In addition, the platform 208 includes an optimization engine 430, which is a hardware and/or software module configured to filter and select specific advertisements to be displayed for the user based on feedback data related to prior associations between web pages and corresponding displayed advertisements.

Furthermore, the platform 208 includes a page processor 460 coupled to a page classifier 470, which is further coupled to respective databases 451 through 456 within the data storage module 210. In one embodiment, the page processor 460 is a hardware and/or software module configured to analyze in real-time content information within a web page to construct page summaries highly informative of the entire page content. The page processor 460 further analyzes data associated with, the web page, such as, for example, the page URL and the referrer URL, to extract one or more keywords relevant to the page content. The page classifier 470 is a hardware and/or software module configured to classify the web page and its associated content information into respective categories of a content database 451 in order to increase the page representation for subsequent advertisement matching.

In one embodiment, each database within the data storage module 210 may, in one embodiment, be implemented as a relational database, or may, in an alternate embodiment, be implemented as a collection of objects in an object-oriented database, in one embodiment, the content database 451 indexes a plurality of web pages and associated content information, each web page being classified according to its perceived themes based on the constructed page summary. The advertising database 453 stores a plurality of advertisements and associated advertising content information, each advertisement being classified according to one or more themes, which characterize the general subject matter of each advertisement.

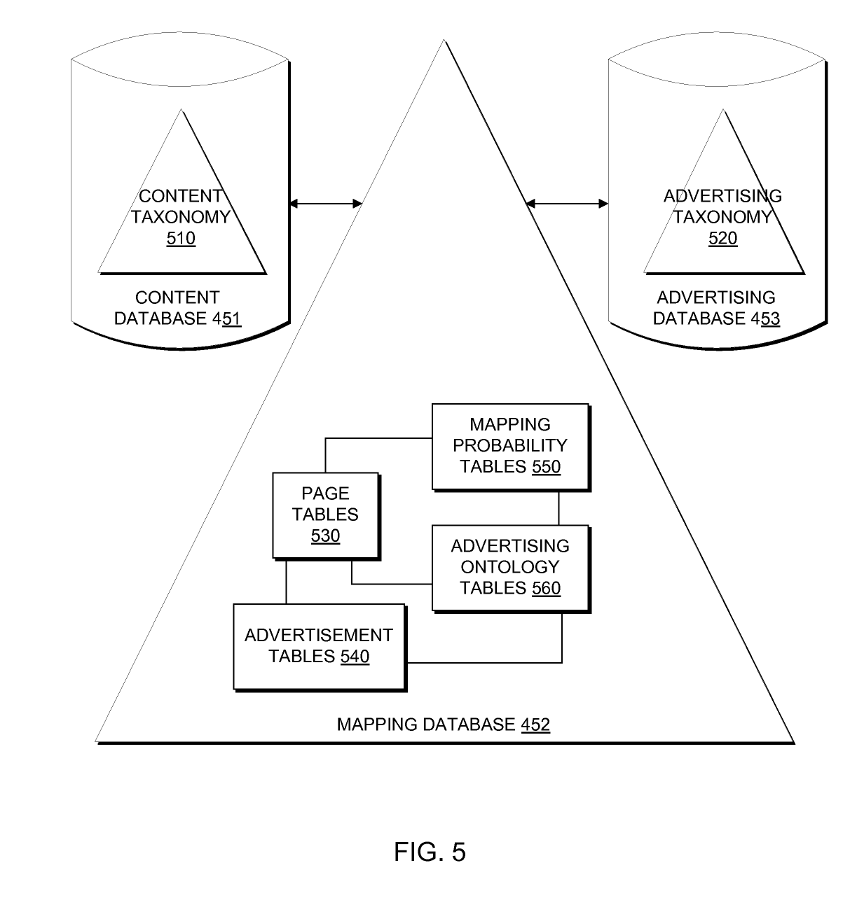

In one embodiment, the mapping database 452 stores a mapping matrix, which includes links between web page information stored within the content database 451 and corresponding advertisements stored within the advertising database 453, as described in further detail below in connection with FIG. 5.

FIG. 5 is a block diagram illustrating a data storage module within the network-based entity, according to one embodiment of the invention. As shown in FIG. 5, in one embodiment, the web pages and associated content information are further organized into a hierarchical content taxonomy 510 within the database 451 based on associations with their respective events of origin and based on various page parameters, such as, for example, page ancestors, anchor text metadata, publisher entity 240 associated with each respective web page, and other features of the web pages. The hierarchical content taxonomy is reviewed, edited, and updated automatically by the processing and matching platform 208, or, in the alternative, manually by editors and/or other third-party entities.

In one embodiment, the advertisements are further organized into a hierarchical advertising taxonomy 520 within the database 453 based on various advertisement parameters, such as, for example, text of each advertisement offer, advertiser entity 250 associated with each respective advertisement, advertiser industry, target page of each specific advertisement, and other features of the stored advertisements. The hierarchical advertising taxonomy is reviewed, edited, and updated automatically by the processing and matching platform 208, or, in the alternative, manually by editors and/or other third-party entities.

The content taxonomy 510 and the advertising taxonomy 520 are represented as hierarchies of nodes. However, it is to be understood that any other representation of a taxonomy used to classify subject matter may be used in conjunction with the system 400 without deviating from the spirit or scope of the invention. In one embodiment, the matching process requires each taxonomy to provide sufficient differentiation between the common commercial topics. For example, classifying all medical related pages into one node will not result into a good classification since both “sore foot” and “flu” pages will end up in the same node. However, the advertisements suitable for these two concepts may be very different.

As a result, in one embodiment, a taxonomy of around 6000 nodes, primarily built for classifying commercial interest queries, rather than pages or ads, is used to obtain sufficient resolution and to classify both web pages and advertisements within the respective taxonomies 510, 520. Alternatively, other taxonomies may be used in conjunction with the system 400 without deviating from the spirit or scope of this invention. Each node in the exemplary taxonomy described above is represented as a collection of exemplary bid phrases or queries that correspond to that node concept. In one embodiment, each node has on average around 100 queries. The queries placed in the taxonomy are high volume queries and queries of high interest to advertisers 250, as indicated by an unusually high cost-per-click (CPC) price, in one embodiment, the taxonomy is populated by human editors using keyword suggestion tools similar to the ones used by advertising agencies, such as, for example, the entity 200, or an agency coupled to the entity 200, to suggest keywords to advertisers 250.

In one embodiment, the mapping database 452 may store web pace information, advertisement information, and associations between the stored web page information and the advertisement information, such as probability scores indicating that certain advertisements match one or more themes of a respective web page and logical associations between advertisement information and web page information, as described in detail below.

In one embodiment, the mapping database 452 may be implemented as a relational database, and includes a number of tables having entries, or records, that are linked by indices and keys. In an alternative embodiment, the mapping database 452 may be implemented as a collection of objects in an object-oriented database. Central to the database 452 shown in FIG. 5 are one or more page tables 530, which contain records for each web page stored within the content taxonomy 510. The database 452 also includes one or more advertisement fables 540, which may be linked to the page tables 530 and may be populated with records for each advertisement stored within the advertising taxonomy 520.

In one embodiment, the mapping database 452 may further include a number of other tables, which may also be linked to the page tables 530 and the advertisement fables 540, such as, for example, tables specifically provided to enable exemplary embodiments of the present invention. One or more mapping probability tables 550 are configured to store multiple probability scores, each score indicating the probability that a certain type of advertisements stored within the advertising taxonomy 520 matches the one or more themes of a respective web page stored within the content taxonomy 510. One or more advertising ontology tables 560 are configured to store logical associations between advertisements stored within the advertising taxonomy 520 and content of the web pages stored within the content taxonomy 510.

In one example, a web page requested by a user contains information about golf related events and location of respective golf courses where the events may take place, and further details a profile of a golf player named John Maytag. The web page is associated with golf-related categories of the content taxonomy 510, such as “Sports” and “Travel.” At the same time, the golf-related web page may be associated, for example, with predetermined luxury-related categories of the content taxonomy 510, such as, for example, “Jewelry,” since it is presumed that golf as a sport may be logically associated with high income participants, which are historically more inclined to purchase luxury consumer products. Thus, the content taxonomy may be represented as follows:

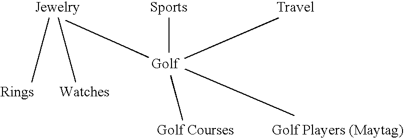

In one embodiment, the advertising taxonomy 520 may contain a similar hierarchical representation and may store, for example, advertisements for golf courses, golf apparel, travel trips, luxury watches, at respective nodes within the taxonomy 520. Furthermore, in our example, the mapping database 452 stores multiple probability scores indicating probabilities that the advertisements described above match the “sports/golf” and “travel” themes of the web page, in addition, the mapping database 452 may also store logical associations showing that advertisements for luxury watches match ontologically the content of the golf-related web page, but advertisements for the “Maytag” brand of dishwashers are not effective on a sports/golf or travel-related web page and receive low scores. As a result, one example of a table illustrating data stored within the mapping database 452 may be represented as follows:

| | GOLF | WATCHES | DISHWASHERS |
|---|---|---|---|
| GOLF | 0.9 | 0.7 | 0 |
| WATCHES | 0.7 | 0.9 | 0.1 |
| DISHWASHERS | 0 | 0.1 | 0.9 |

In the table shown above, the vertical categories correspond to web page information and the horizontal categories correspond to advertising information stored respectively within the mapping database 452. The table illustrates that the likelihood that golf-related advertisements and watch-related advertisements match golf-related and watch-related web pages is high, as reflected in high probability scores, while the dishwasher-related advertisements receive low probability scores in relation to the golf-related and watch-related web pages, but high probability scores on appliance/dishwasher-related pages. In one embodiment, the mapping matrix shown above is learned and populated by aggregating feedback information on click events performed by user entities 230 and by tracking the number of advertisement impressions on particular web pages.

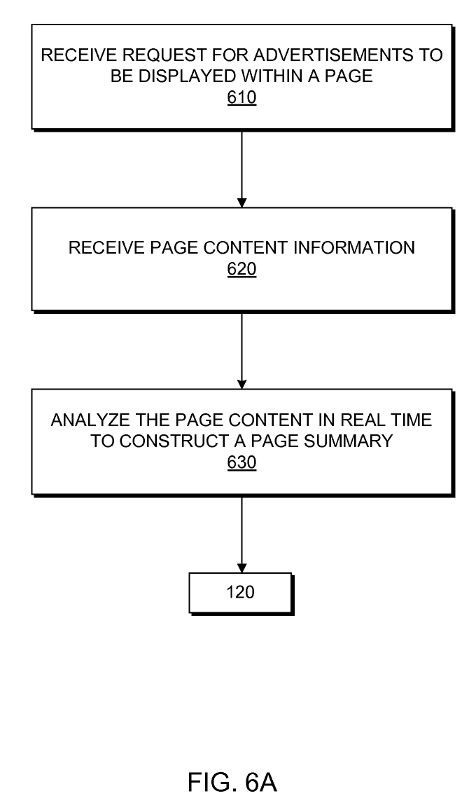

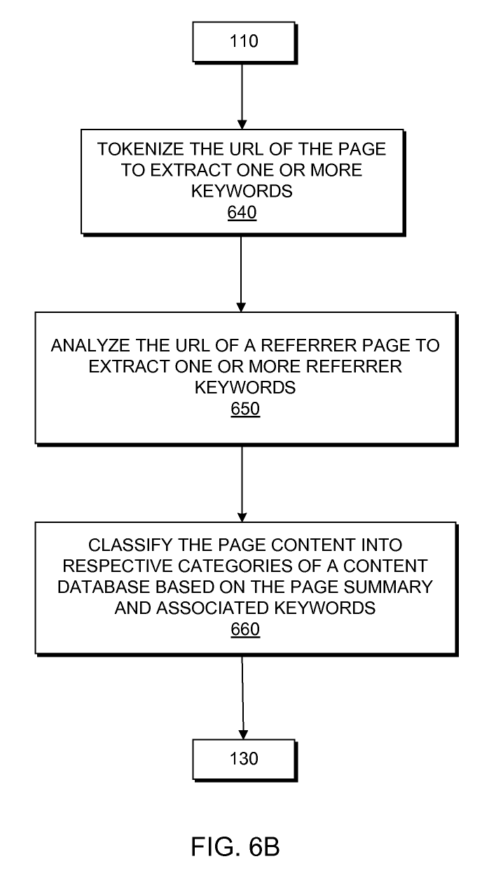

FIG. 6A is a flow diagram illustrating a method to process page content information received at the network-based entity, according to one embodiment of the invention. As shown in FIG. 6A, at processing block 610, a request for advertisements to be displayed within a web page requested by a user is received. In one embodiment, upon a request initiated by a browser residing in the client machine 232 of the user entity 230, and upon display of the requested page in a display device of the client machine 232, a JavaScript code request embedded into the web page, or, in the alternative, loaded from a server, is transmitted to the web servers 202 within the entity 200.

At processing block 620, the web page and its associated page content information is received. In one embodiment, the request for advertisements transmitted by the user entities 230 contains the associated page content information, and additional data related to the web page, such as, for example, the web page URL and the referrer URL.

In one embodiment, the web servers 202 receive the web page, and its associated content information, such as, for example, a golf-related sports web page, via the network 220 from the user entities 230, and/or the publisher entities 240, and/or other entities connected to the network 220. The web servers 202 toward the page content information and the associated data to the processing and matching platform 208.

At processing block 630, the content of the page is analyzed in real-time to construct a page summary. In one embodiment, the page processor 460 within the platform 208 receives the web page content information and analyzes the content information to construct the page summary according to known page summarization techniques.

The summarization techniques are divided into extractive and non-extractive approaches. The page processor 460 uses extractive techniques to summarize the page content by retrieving selected terms and phrases that are already present within the web page. Alternatively, the page processor 460 analyzes the entire web page as a whole and rewrites its content in a concise manner.

Since the input is an HTML document, its HTML markup provides hints to the relative importance of the various page segments. Thus, the page processor 460 avoids time-consuming analysis of the text by taking cues from the structure of the document. When the users browser displays the web page requested by the user entities 230, the browser performs HTML parsing prior to rendering, hence the JavaScript code embedded into the web page has easy access to the Document Object Model (DOM) representation of the parsed HTML document.

Some page summarization techniques are described in detail, for example, in “Efficient Web Browsing On Handheld Devices Using Page And Form Summarization,” by Orkut Buyukkokten et al., in ACM Transactions on Information Systems, 20(1):82-115, January 2002, and in “Summarization As Feature Selection For Text Categorization,” by Aleksander Kolcz et al., in SIGIR'01, pages 365-370, 2001, which are incorporated by reference herein in their entirety.

Referring back to FIG. 6A, the procedure then jumps to processing block 120 described in detail in connection with FIG. 1.

FIG. 6B is a flow diagram illustrating a method to process data associated to the web page and to classify the page content, according to one embodiment of the invention. As shown in FIG. 6B, at processing block 640, the URL of the web page is tokenized to extract one or more keywords relevant to the page content. In one embodiment, the page processor 460 tokenizes the URL of the web page to extract the relevant keywords,

At processing block 650, the URL of the referrer web page is analyzed to extract one or more referrer keywords. In one embodiment, the page processor 460 tokenizes the referrer URL to extract one or more referrer keywords relevant to the user intent and the content of the referrer page, such as, for example, if the referrer web page was a hub or a search results page.

At processing block 660, the page content is classified in real-time into respective categories of a content database based on the page summary and the retrieved keywords. In one embodiment, the page classifier 470 receives the page summary and the extracted keywords and referrer keywords and classifies the page content in real-time in the content database 451 within, for example, the content taxonomy 510. In the case of the golf-related web page, the semantic matching engine 410 classifies the page under the “sports” and the “travel” categories of the content taxonomy 510.

Referring back to FIG. 6B, the procedure then jumps to processing block 130 described in detail in connection with FIG. 1.

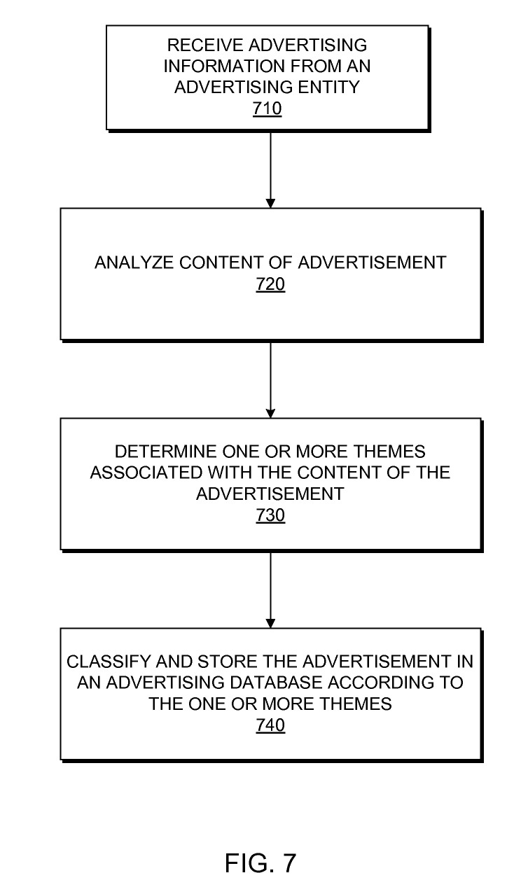

FIG. 7 is a flow diagram illustrating a method to process advertisements received at the network-based entity, according to one embodiment of the invention. As shown in FIG. 7, at processing block 710, advertising information is received. In one embodiment, the web servers 202 receive an event, such as, for example, an advertisement, and its associated content information, such as, for example, a golf-related sports advertisement, via the network 220 from advertiser entities 250 connected to the network 220. The web servers 202 forward the advertisement to the advertising servers 204.

At processing block 720, the content of the advertisement is analyzed, in one embodiment, the advertising servers 204 within the entity 200 receive the advertisement and parse the advertisement to analyze its associated content information and to extract predetermined features related to the content.

At processing block 730, one or more themes associated with the content of the advertisement are determined. In one embodiment, the advertising servers 204 extract one or more themes associated with the parsed advertising content information. Considering the case of a golf-related sports advertisement containing information about golf clubs and location of stores carrying such golf clubs, the advertising sewers 204 extract a “sports” theme for the received advertisement.

At processing block 740, the advertisement is classified and stored in an advertising database according to the extracted themes. In one embodiment, the advertising servers 204 classify and store the received advertisement in the advertising database 453 within, for example, the advertising taxonomy 520, according to the themes of the advertisement. In the case of the advertisement for golf clubs, the advertising servers 204 classify the advertisement under the “sports” category of the advertising taxonomy 520.

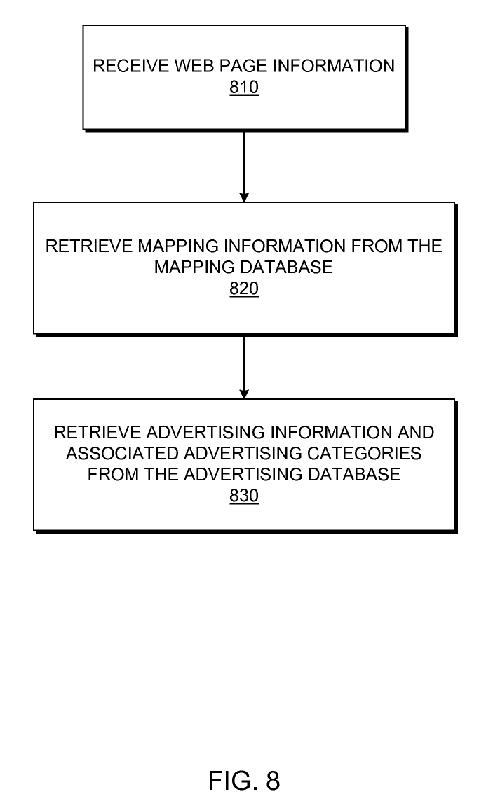

FIG. 8 is a flow diagram illustrating a method to facilitate semantic matching of content to corresponding advertising information, according to one embodiment of the invention. The processing sequence described in FIG. 8 accomplishes the selection of advertisements and their associated advertising categories related to one or more themes of a requested web page.

As shown in FIG. 8, at processing block 810, a request for advertisements and related web page information is received, the request containing a web page identifier, such as, for example, a Universal Resource Locator (URL), in one embodiment, the web servers 202 receive a request for advertisements from a user entity 230 via the client machine 232 and the network 220 or, in the alternative, from the publisher entities 240. The web servers 202 further forward the request and the web page identifier to the processing and matching platform 208 within the entity 200.

For example, if the user entity 230 requests advertisements for a web page that presents information about a golf player named “John Maytag,” the semantic matching engine 410 retrieves information related to the golf player from the content taxonomy 510, such as, for example, the associated categories “sports/golf,” “travel/golf,” and other related content categories.

At processing block 820, mapping information is retrieved from the mapping database based on the retrieved web page information. In one embodiment, the semantic matching engine 410 accesses corresponding tables within the mapping database 452 to retrieve mapping information related to the retrieved web page categories. The semantic matching engine 410 uses the page tables 530, the advertisement tables 540, the mapping probability tables 550, and the advertising ontology tables 560 to retrieve a mapping of the web page to advertisements stored within the advertising taxonomy 520. Considering the John Maytag golf-related web page information, the semantic matching engine 410 maps the “sports/golf” category and the “jewelry/watches” category to corresponding advertising categories based on the corresponding probability scores stored within the mapping probability tables 550 and the advertising ontology information stored within the advertising ontology tables 560.

At processing block 830, advertising information and associated advertising categories are retrieved from the advertising database based on the mapping information. In one embodiment, the semantic matching engine 410 uses the mapping information to access the advertising taxonomy 520 within the advertising database 453 and to retrieve advertisements and their associated advertising categories that match the mapping information, in one example, the semantic matching engine 410 uses the mapping of the “sports/golf” category and the “jewelry/watches” category of the web page to retrieve advertisements related to the “sports/golf” advertising category and the “jewelry/watches” advertising category stored within the advertising taxonomy 520.

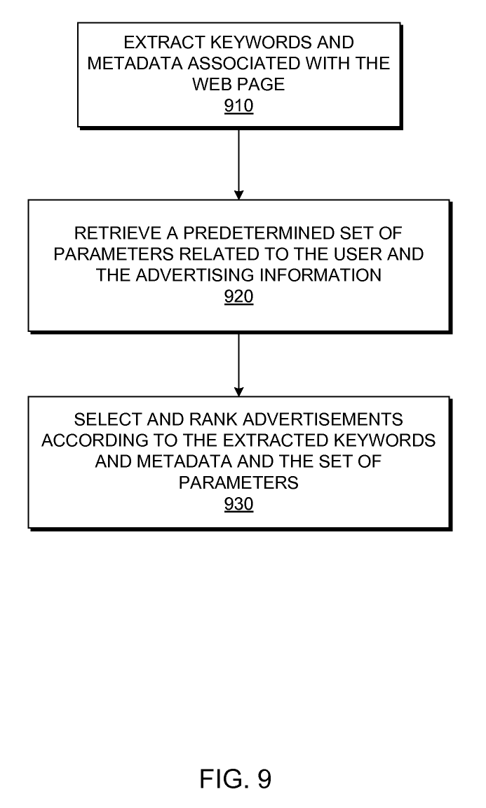

FIG. 9 is a flow diagram illustrating a method to facilitate syntactic matching of content to corresponding advertising information, according to one embodiment of the invention. The processing sequence described in FIG. 9 accomplishes the selection and ranking of advertisements that closely match text and metadata within the web page and further match a set of predetermined parameters stored within the multiple databases of the data storage module 210.

At processing block 910, keywords and associated metadata information are extracted from the web page, in one embodiment, the semantic matching engine 410 transmits web page information to the text and metadata extractor 440 via the syntactic matching engine 420. The text and metadata extractor 440 extracts keywords and metadata from the web page, such as, for example, actual page keywords, anchor text metadata, and other syntactic parameters.

At processing block 920, a predetermined set of parameters related to the user and the advertising information are retrieved, in one embodiment, the syntactic matching engine 420 accesses various databases within the data storage module 210 to retrieve a predetermined set of parameters.

The syntactic matching engine 420 retrieves user profile information related to the user entity 230 from the user database 455, such as, for example, geographical location of the user (e.g., San Francisco Bay Area), user account information, and other components of the user profile,

The syntactic matching engine 420 further retrieves business rules from the business rules database 454, such as, for example, rules expressing constraints on the display of certain advertisements in association with specific web pages (e.g., “Cannot display advertisements related to a specific advertiser on a web page maintained by a web site sponsored by a competitor of the advertiser”).

The syntactic matching engine 420 further retrieves advertisement parameters related to each of the retrieved advertisements from the supply/budget databases 456, such as, for example, budget constraints for each advertisement, a click-through-rate (CTR) threshold associated with each advertisement, a maximum number of impressions required by the advertiser entity 250, and other parameters related to the financial aspects of the advertisements.

At processing block 930, advertisements are further selected and ranked according to the extracted keywords and associated metadata of the web page and the set of retrieved parameters. In one embodiment, the syntactic matching engine 420 selects advertisements based on the extracted keywords, the extracted metadata of the web page, and the set of retrieved parameters and further ranks the selected advertisements based on the above criteria.

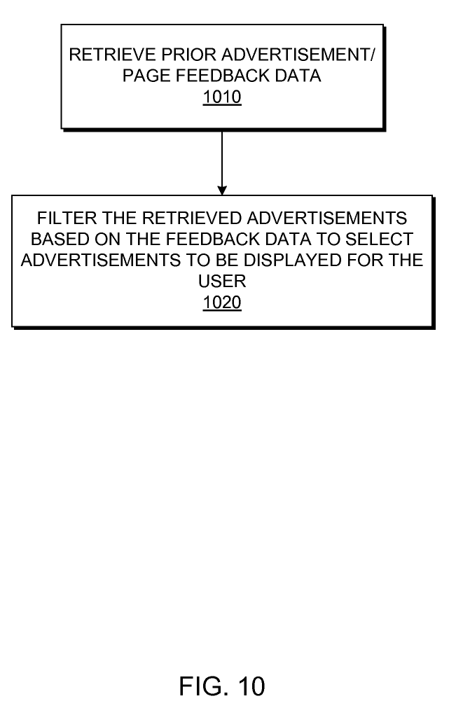

FIG. 10 is a flow diagram illustrating a method to optimize selected advertisements for subsequent display to the user, according to one embodiment of the invention. The processing sequence described in FIG. 10 accomplishes the optimization of ranked advertisements to obtain advertisements to be displayed for the user.

As shown in FIG. 10, at processing block 1010, prior advertisement/page feedback data is retrieved. In one embodiment, the optimization engine 430 accesses the content database 451, the mapping database 452, and the advertising database 453 to retrieve feedback data containing prior instances of pairing of advertisements with web pages similar to the requested web page. The feedback data contains short-term advertisement/page pairs and is continuously updated at the entity 200.

At processing block 1020, the advertisements selected and ranked at blocks described in connection with FIG. 9 are further filtered based on the feedback data to select advertisements to be displayed for the user. In one embodiment, the optimization engine 430 receives the ranked list of advertisements from the syntactic matching engine 420 and filters the entire list of advertisements based on the short-term advertisement/page feedback data to obtain optimized advertisements ready to be displayed on the client machine 232 of the user entity 230 within the requested web page. The optimization engine 430 further forwards the optimized advertisements to the web servers 202 to be transmitted to the client machine 232 via the network 220, or, in the alternative, to the publisher entities 240.

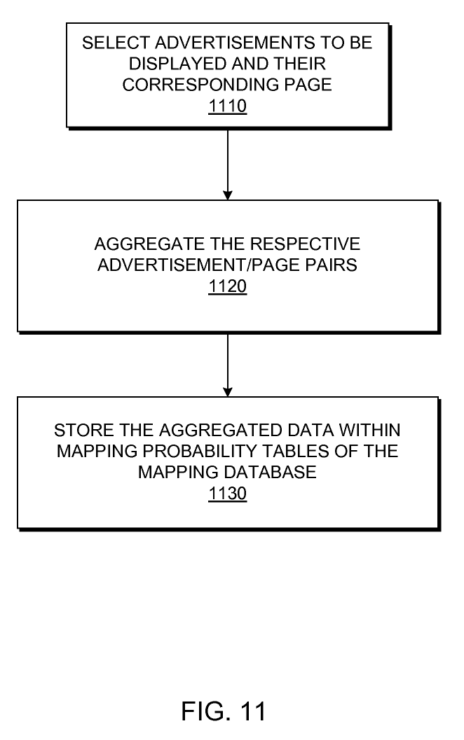

FIG. 11 is a flow diagram illustrating a method to update a mapping database within the data storage module based on the optimized advertisements and the associated content, according to one embodiment of the invention. The processing sequence described in FIG. 11 accomplishes the storage of optimized advertisements within the mapping database.

As shown in FIG. 11, at processing block 1110, optimized advertisements to be displayed in connection with a web page requested by a user entity 230 are selected. In one embodiment, the optimization engine 430 within the platform 208 selects the optimized advertisements to be displayed with the corresponding web page on the client machine 232 of the user entity 230.

At processing block 1120, the respective advertisement/page pairs are aggregated. In one embodiment, the optimization engine 430 aggregates the selected advertisements and their corresponding web page to eliminate any duplicate advertisement/page pair and to obtain aggregated data.

Finally, at processing block 1130, the aggregated data is stored within the mapping database 452. In one embodiment, the optimization engine 430 stores the aggregated data within the mapping probability tables 550 of the mapping database 452 and updates the probability scores accordingly to reflect the newly paired advertisement information and web page information. At the same time, in one embodiment, the content taxonomy 510 and the advertising taxonomy 520 may also be updated to reflect the new advertisement/page category information within the aggregated data.

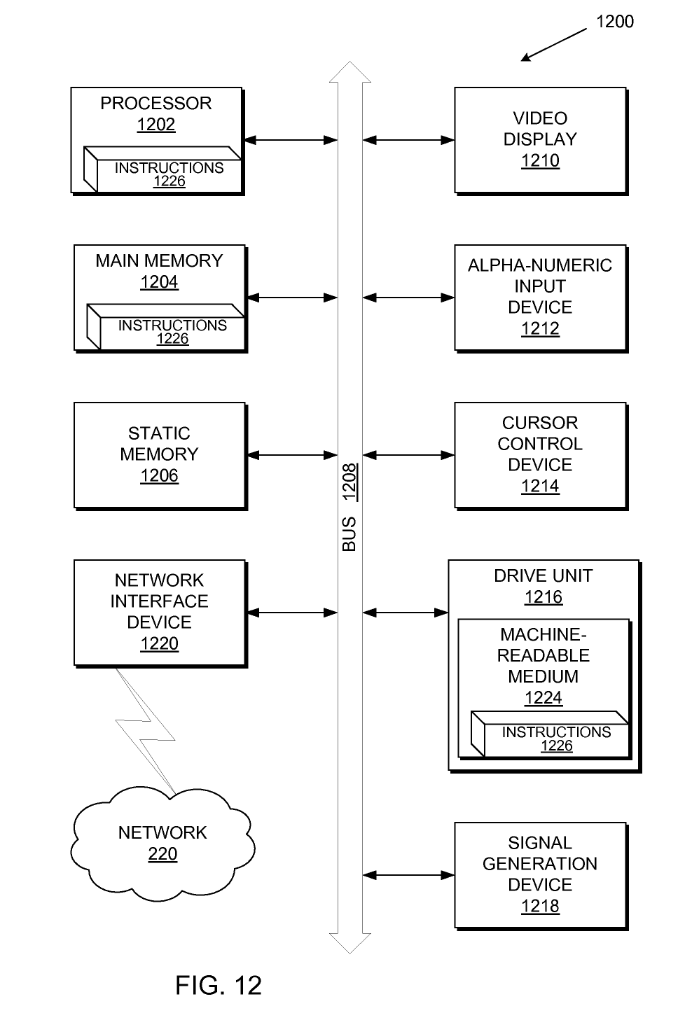

FIG. 12 shows a diagrammatic representation of a machine in the exemplary form of a computer system 1200 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1200 includes a processor 1202, a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1218 (e.g., a speaker), and a network interface device 1220.

The disk drive unit 1216 includes a machine-readable medium 1224 on which is stored a set of instructions (i.e., software) 1226 embodying any one, or all, of the methodologies described above. The software 1226 is also shown to reside, completely or at least partially, within the main memory 1204 and/or within the processor 1202. The software 1226 may further be transmitted or received via the network interface device 1220 over the network 220,

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
receiving a request for advertising information over a network, said advertising information to be displayed for a user entity in association with content information within a web page requested by said user entity, said request containing said content information, a web page identifier, and additional data associated with said web page;
analyzing said content information in real-time to construct a page summary of said web page;
analyzing said web page identifier and said additional data in real-time to extract at least one keyword relevant to said content information; and
determining said advertising information in real-time based on said page summary and said at least one extracted keyword.

2. The method according to claim 1, wherein said receiving further comprises:
receiving said request for advertising information from a user entity over said network.

3. The method according to claim 1, wherein said receiving further comprises:
receiving said request for advertising information from a publisher entity over said network.

4. The method according to claim 1, wherein analyzing said content information further comprises:
extracting selected terms and phrases from said content information; and
constructing said page summary based on said terms and phrases.

5. The method according to claim 1, wherein analyzing said web page identifier and said additional data further comprises:
tokenizing said web page identifier to extract at least one keyword relevant to said web page; and
tokenizing a referrer page identifier within said additional data to extract at least one referrer keyword relevant to said content information.

6. The method according to claim 1, wherein said determining further comprises:
classifying said web page and said associated content information into respective content categories within a content database based on said page summary and said at least one keyword.

7. A system comprising:
at least one web server to receive a request for advertising information over a network, said advertising information to be displayed for a user entity in association with content information within a web page requested by said user entity, said request containing said content information, a web page identifier, and additional data associated with said web page; and
a processing and matching platform coupled to said at least one web server to analyze said content information in real-time to construct a page summary of said web page, to analyze said web page identifier and said additional data in real-time to extract at least one keyword relevant to said content information, and to determine in real-time said advertising information based on said page summary and said at least one extracted keyword.

8. The system according to claim 7, wherein said at least one web server further receives said request for advertising information from a user entity over said network.

9. The system according to claim 7, wherein said at least one web server further receives said request for advertising information from a publisher entity over said network.

10. The system according to claim 7, wherein said platform further comprises a page processor to extract selected terms and phrases from said content information and to construct said page summary based on said terms and phrases.

11. The system according to claim 7, wherein said platform further comprises a page processor to tokenize said web page identifier to extract at least one keyword relevant to said web page and to tokenize a referrer page identifier within said additional data to extract at least one referrer keyword relevant to said content information.

12. The system according to claim 7, wherein said platform further comprises a page classifier to classify said web page and said associated content information into respective content categories within a content database based on said page summary and said at least one keyword.

13. A computer readable medium containing executable instructions, which, when executed in a processing system, cause said system to perform a method comprising:
receiving a request for advertising information over a network, said advertising information to be displayed for a user entity in association with content information within a web page requested by said user entity, said request containing said content information, a web page identifier, and additional data associated with said web page;
analyzing said content information in real-time to construct a page summary of said web page;
analyzing said web page identifier and said additional data in real-time to extract at least one keyword relevant to said content information; and
determining said advertising information in real-time based on said page summary and said at least one extracted keyword.

14. The computer readable medium according to claim 13, wherein said receiving further comprises:
receiving said request for advertising information from a user entity over said network.

15. The computer readable medium according to claim 13, wherein said receiving further comprises:
receiving said request for advertising information from a publisher entity over said network.

16. The computer readable medium according to claim 13, wherein analyzing said content information further comprises:
extracting selected terms and phrases from said content information; and
constructing said page summary based on said terms and phrases.

17. The computer readable medium according to claim 13, wherein analyzing said web page identifier and said additional data further comprises:
tokenizing said web page identifier to extract at least one keyword relevant to said web page; and
tokenizing a referrer page identifier within said additional data to extract at least one referrer keyword relevant to said content information.

18. The computer readable medium according to claim 13, wherein said determining further comprises:
classifying said web page and said associated content information into respective content categories within a content database based on said page summary and said at least one keyword.
